(19) United States
(12) Patent Application Publication
(10) Pub. No.: US 2026/0025072 A1
(43) Pub. Date: Jan. 22, 2026

(54) VEHICLE-TO-VEHICLE CHARGING USING VOLTAGE CONVERTER SYSTEM WITH BYPASS SWITCHES FOR REDUCED LOSSES

(71) Applicant: GM GLOBAL TECHNOLOGY OPERATIONS LLC, Detroit, MI (US)

(72) Inventors: Rashmi Prasad, Troy, MI (US); Chandra S. Namuduri, Troy, MI (US)

(73) Assignee: GM GLOBAL TECHNOLOGY OPERATIONS LLC, Detroit, MI (US)

(21) Appl. No.: 18/777,646

(22) Filed: Jul. 19, 2024

(51) Int. Cl. H02M 3/158; B60L 53/20; B60L 53/53; H02J 7/34; H02M 1/00

(52) U.S. Cl. CPC H02M 3/1582; B60L 53/20; B60L 53/53; H02J 7/342; H02M 1/0054; B60L 2210/14; H02J 2207/20

(57) ABSTRACT

A direct current-to-direct current (DC-DC) converter system for charging between respective charge-providing and receiving donor and recipients systems includes input and output filter capacitors connected to a rechargeable energy storage system (RESS) of the donor and recipient, and a link capacitor in parallel with input and output stages of the system. A boost stage has a first switching control circuit inclusive of a first plurality of switches. A buck stage has a second control circuit inclusive of a second plurality of switches. The first and second pluralities of switches have respective bypass switches. A controller identifies respective voltage ranges of the donor and recipient. In response to the voltage ranges, the controller selectively bypasses a charging path in the boost or buck stages during charging by closing the first or second bypass switch. This action minimizes losses in the converter system.

### INTRODUCTION

Battery electric vehicles, plug-in hybrid electric vehicles, extended-range electric vehicles, and other electrified mobile systems, collectively referred to herein as electric vehicles (EVs) for simplicity, are equipped with an electrified powertrain system. An electrified powertrain system of a motor vehicle for instance includes one or more electric traction motors connected to a set of road wheels. A battery management system of the EV controls discharge of a high-voltage traction battery pack during propulsion modes to energize the electric traction motor(s) and produce output torque. The EV is thereby propelled along a road surface via electrically-driven rotation of the road wheels, with engine-drive rotation also being possible in the above-noted hybrid electric and extended-range electric vehicle configurations.

Electrochemical battery cells of a depleted traction battery pack are selectively rechargeable using an offboard plug-in charging process. As appreciated in the art, offboard charging of a battery electric system requires the battery pack to be electrically connected to Electric Vehicle Supply Equipment (EVSE), i.e., an offboard charging station, via a suitably configured charging cable. Communication and control circuitry and respective controllers of the charging station and the EV establish two-way communications in accordance with a suitable charging protocol. The charging station thereafter offloads a charging current to the depleted battery pack to charge the individual battery cells.

### SUMMARY

Disclosed herein are a direct current-to-direct current (DC-DC) converter architecture for use in a representative portable charging unit and method for performing a charging operation between a charge-providing electrical system (“donor”) and a charge-receiving electrical system (“recipient”) using the portable charging unit and a resident DC-DC converter system. While example donor and recipients are configured as representative battery electric systems, the present teachings may encompass various other rechargeable energy storage systems (RESSs), including but not limited to on-board fuel cells, ultracapacitors, or hybrid-type alternative electrical storage. Therefore, battery electric systems described herein are merely representative of the present teachings and not limiting thereof.

The disclosed portable charging architecture and associated charging strategy enables the transfer of high-voltage power from the donor RESS to the recipient RESS with reduced switching and conductive losses of types commonly associated with employing multiple power conversion stages in a charging path. Such benefits are provide using selective control of first and second bypass switches as set forth herein.

In a representative/non-limiting construction, the donor and recipient are configured as battery electric systems in the form of electric vehicles (EVs), for instance full battery electric, plug-in hybrid, extended range electric, or other electrified mobile systems having a high-voltage direct current (DC) traction battery pack. However, the present teachings may also be extended to charging events performed using stationary or non-vehicular donor/recipients within the scope of the present disclosure, with the described vehicle-to-vehicle (V2V) charging operation using donor and recipient EVs being just one possible DC-DC charging application.

In a particular embodiment, a DC-DC converter system for use in a charging session performed between a charge-providing electrical system (“donor”) and a charge-receiving electrical system (“recipient”) includes an input filter capacitor connected to an input stage of the DC-DC converter system, an output filter capacitor connected to an output stage of the DC-DC converter system, and link capacitor disposed in parallel with and between the input and output stages. A boost converter circuit stage (“boost stage”) has a first switching control circuit. A buck converter circuit stage (“buck stage”) of the DC-DC converter system includes a second switching control circuit, with the second switching control circuit including a second plurality of switches. The first and second pluralities of switches each include a bypass switch, i.e., a first bypass switch and a second bypass switch, respectively.

As part of this representative construction, an electronic control system (“system controller”) is in communication with the first and second pluralities of switches. The system controller is configured to identify respective voltage ranges of a donor-side rechargeable energy storage system (RESS) and a recipient-side RESS. In response to the respective voltage ranges, the controller selectively bypasses a charging path in circuits of the boost or buck converter stage by closing one of the first or second bypass switches. This switching control action minimizes losses in the DC-DC converter system.

The boost stage in some implementations is connected to the input side of the system/donor-side RESS. The buck stage in such an embodiment is connected to the output side/recipient-side RESS, such that the DC-DC converter system is configured as a boost-buck converter having respective voltage-increasing and voltage-reducing boost and buck stages in a charge path extending from the donor to the recipient. The system controller is configured to selectively bypass the buck stage or boost stage by respectively opening or closing the first or second bypass switch, respectively. The controller is optionally programmed to close the first bypass switch and open the second bypass switch when an input voltage to the boost-buck converter exceeds an output voltage by more than a predetermined fraction, e.g., about 10 percent.

In one or more embodiments, the circuitry of the boost stage is connected to the recipient-side ESS and that of the buck stage is connected to the donor-side RESS, such that the DC-DC converter system is configured as a buck-boost converter. The system controller is configured to selectively bypass an upper or lower switch of the buck-boost converter in this embodiment via operation of the first or second bypass switch, respectively. The controller is programmed to close the second bypass switch and open the first bypass switch when the input voltage exceeds the output voltage by more than the above-noted predetermined fraction.

The system controller in or more implementations maintains the first and second bypass switches in an OPEN state when, during the charging process, a voltage level of the donor-side RESS overlaps or stays within a predetermined range of a voltage level of the recipient-side RESS. The system controller in some implementations is configured to pre-charge the input filter capacitor, the output filter capacitor, and the link capacitor prior to closing the first or second bypass switches so as to minimize an inrush current.

The DC-DC converter system may be bi-directional in one or more implementations.

In one or more configurations, the first and second bypass switches are embodied as solid-state switches having an ON state voltage that is less than a predetermined fraction or percentage of an ON-state voltage of remaining switches of the first and second switching circuits, specifically at a rated current level of the buck and boost stages. About 10-20% is usable as a possible percentage in a non-limiting implementation.

The first and second bypass switches may optionally include electromechanical relays or contactors. The DC-DC converter system may be used as part of a vehicle-to-vehicle (V2V) charging unit, in which case the system controller is an integral part of the V2V charging unit. The donor and recipient may be embodied as electric vehicles (EVs) as noted above.

Also disclosed herein is a vehicle system having a charge-providing donor EV, a charge-receiving recipient EV, and a V2V charging unit having a system controller and a DC-DC converter system operable for performing a V2V charging session between the donor and recipient EVs. The DC-DC converter may include an input filter capacitor connected to an input stage of the system, an output filter capacitor connected to an output stage of the system, and a link capacitor disposed in parallel with and between the input and output stages. The identity of the stages as a boost stage or buck stage varies with the application as set forth herein.

The boost stage in accordance with a representative embodiment has a first switching control circuit inclusive of a first plurality of switches, with the constituent switches of the first plurality of switches including a first bypass switch. A buck stage includes a second switching control circuit having a second plurality of switches. The second plurality of switches includes a second bypass switch. The system controller is configured to identify respective voltage ranges of the donor-side RESS (input voltage) and the recipient-side RESS (output voltage). In response to the respective voltage ranges, the system controller selectively bypasses a charging path in the boost or buck stage as needed by closing the first or second bypass switch, thus minimizing switching and conduction losses in the DC-DC converter system.

An aspect of the disclosure pertains to a V2V charging method, an embodiment of which includes identifying, via a system controller, respective voltage ranges of a donor-side RESS and a recipient-side RESS of a respective donor EV and recipient EV. In response to the respective voltage ranges, the method includes selectively bypassing a charging path in a boost stage or a buck stage of a DC-DC converter system of a portable V2V charging unit connected between the donor and recipient EVs. This occurs by closing a first bypass switch in the boost stage or a second bypass switch in the buck stage to minimize the above-noted losses in the DC-DC converter system.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

FIG. 1 is an illustration of a representative direct charging session being performed between a charge-providing electrical system in the non-limiting form of an electrical vehicle (“donor EV”) and a charge-receiving electrical system in the non-limiting form of an electrical vehicle (“recipient EV”) using a portable vehicle-to-vehicle (V2V) charging unit having a resident low-loss direct current-to-direct current (DC-DC) converter system as disclosed herein.

FIG. 2 illustrates a representative embodiment of the portable V2V charging unit of FIG. 1.

FIGS. 3A and 3B illustrate representative embodiments of the DC-DC converter system shown schematically FIG. 1.

FIG. 4 is a table describing possible voltage levels and switch states for the representative DC-DC converter system of FIG. 3A.

The present disclosure may be modified or embodied in alternative forms, with representative embodiments shown in the drawings and described in detail below. Inventive aspects of the present disclosure are not limited to the disclosed embodiments. Rather, the present disclosure is intended to cover alternatives falling within the scope of the disclosure as defined by the appended claims.

### DETAILED DESCRIPTION

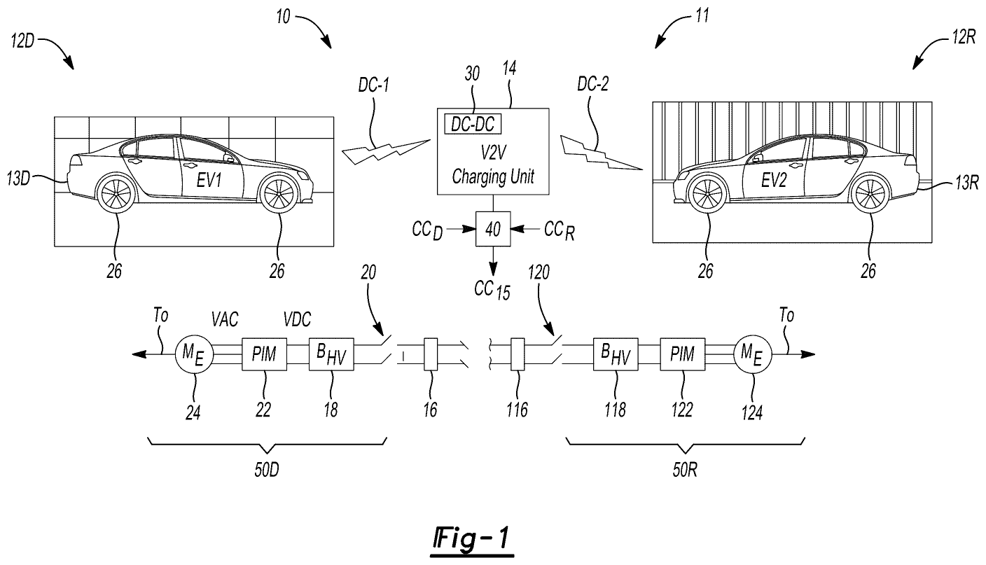

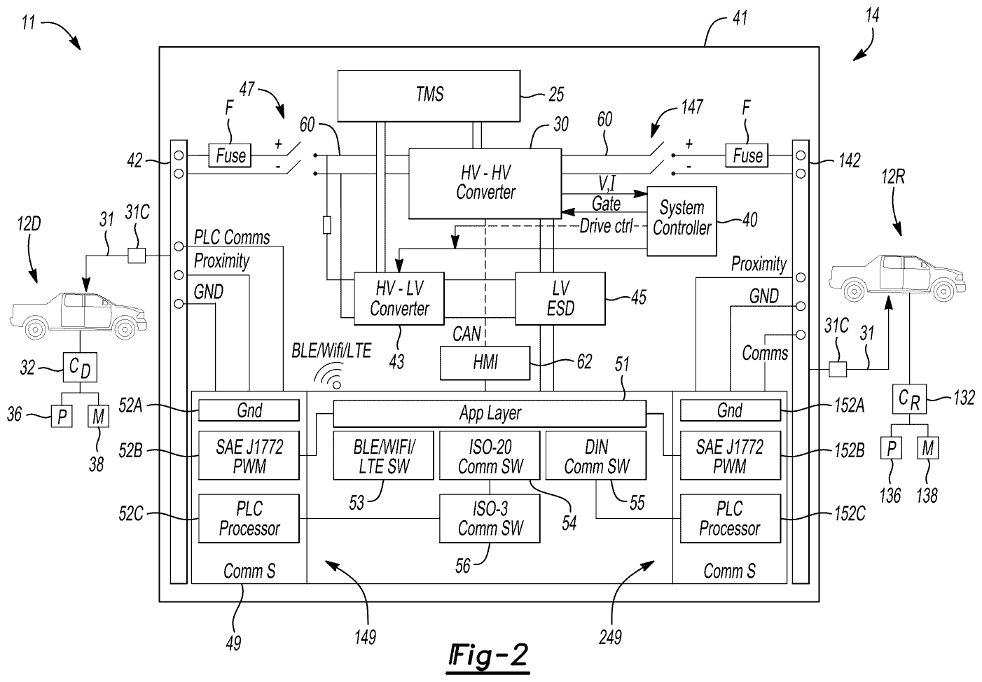

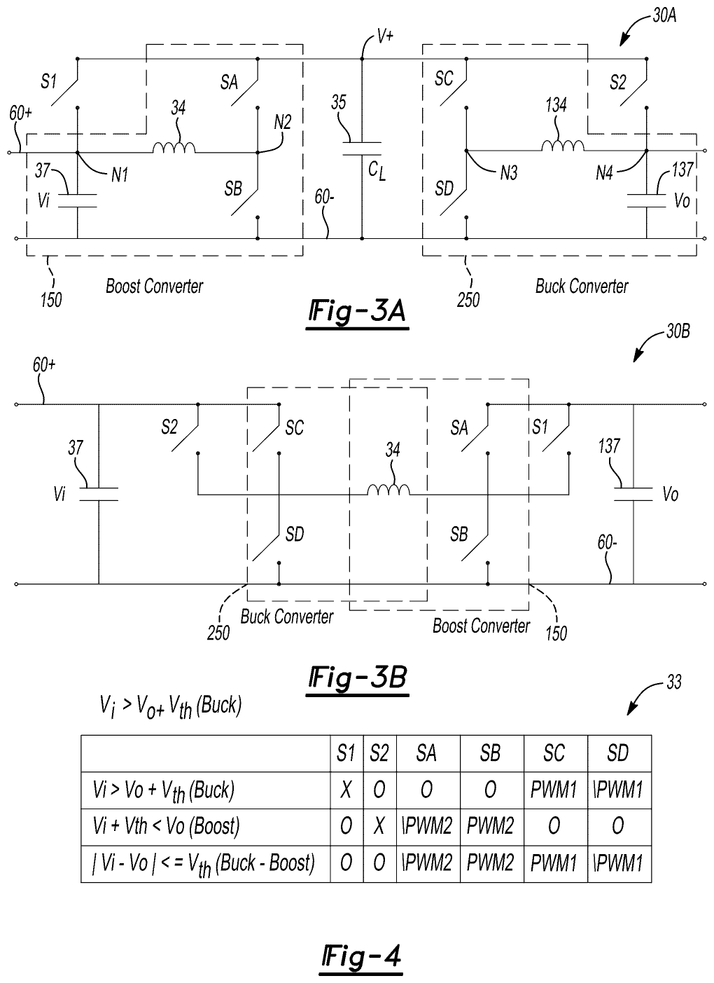

Referring to the drawings, wherein like reference numbers refer to like features throughout the several views, FIG. 1 depicts a representative vehicle-to-vehicle (V2V) charging process 10 involving a vehicle system 11 having a charge-providing electrical system 12D and a charge-receiving electrical system 12R. During the illustrated V2V charging process 10, the charge-providing battery electric system 12D, hereinafter referred to as a donor electric vehicle (EV) 12D for clarity, which is also labeled EV1 in FIG. 1, offloads a high-voltage direct current (DC) charging current (DC-1) to a portable V2V charging unit 14, a representative embodiment of which is illustrated in FIG. 2. The V2V charging unit 14 as contemplated herein includes a direct current-to-direct current (DC-DC) converter system 30, representative embodiments of which are illustrated in FIGS. 3A and 3B. A resident system controller 40 of the V2V charging unit 14 is programmed and operable for controlling the DC-DC converter system 30 during operation of the V2V charging unit 14 as set forth below with reference to FIG. 4.

The V2V charging unit 14 shown schematically in FIG. 1 outputs a DC charging current (DC-2) to the charge-receiving electrical system 12R, hereinafter referred to as a recipient EV 12R (EV2) in keeping with the exemplary V2V embodiment. From the perspective of the recipient EV 12R, the donor EV 12D and the V2V charging unit 14 together appear as an electric vehicle supply equipment (EVSE) node, i.e., an offboard charging station. However, in contrast to stationary offboard charging stations capable of providing DC charging functionality, the portability and configured functionality of the V2V charging unit 14 using the DC-DC converter system 15 of the present disclosure offers owners/operators of electrified systems the benefit of enhanced charging mobility, reduced range anxiety, and reduced switching and conduction losses, among other attendant benefits.

As used herein, the term “electric vehicle” may encompass a wide range of mobile electrified systems. Although motor vehicles are shown in FIG. 1 to illustrate a possible implementation of the V2V charging unit 14, those skilled in the art will appreciate that the present teachings may be extended to a host of electrified systems having a rechargeable energy storage system (RESS) on-board, including but not necessarily limited to rail vehicles, aircraft, boats, farm vehicles, delivery, service/roadside service, or transportation vehicles, etc. The scenario of FIG. 1 is therefore illustrative of just one possible approach.

In the representative construction of FIG. 1, the donor EV 12D and the recipient EV 12R may respectively include a body 13D and 13R and a corresponding electric powertrain system 50D and 50R. In a typical configuration, the donor EV 12D includes a charging port 16 that is connected to a high-voltage (HV) electrochemical traction battery pack (BHV), referred to herein as a donor-side RESS 18. That is, while lithium-ion or other high-energy batteries are described herein for non-limiting battery electric embodiments, the donor-side RESS 18 (and a recipient-side RESS 118 as described herein) may include, e.g., fuel cells, ultracapacitors, or hybrid-type alternative electrical storage. A set of HV electrical contactors 20 or another application suitable high-voltage switching device may be used to connect/disconnect the donor-side RESS 18. The donor-side RESS 18 in one or more embodiments is connected to a power inverter module (PIM) 22, i.e., an inverter circuit. During a discharging mode, the donor-side RESS 18 delivers a DC voltage (VDC) to a DC-side of the PIM 22. The PIM 22, using ON/OFF conductive state control of multiple solid-state semiconductor switches (not shown) such as insulated-gate bipolar transistors (IGBTs), metal-oxide-semiconductor field effect transistors (MOSFETs), thyristors, or the like, is driven by pulse-width modulation or another suitable switching control technique to convert a DC voltage waveform to an alternating current (AC) voltage waveform and vice versa, as appreciated in the art. That is, switching control of the PIM 22 ultimately converts the DC input voltage from the donor-side RESS 18 into an AC voltage (VAC) suitable for energizing phase windings of an electric traction motor (ME) 24, thus causing machine rotation. Output torque (arrow To) from the electric traction motor 24 may be delivered to one or more road wheels 26 of the donor EV 12D or another load when the illustrated charging process is not being performed.

The recipient EV 12R shown in FIG. 1 may be similarly or identically configured to include a corresponding charge port 116, a recipient-side RESS 118, contactors 120, a PIM 122, and an electric traction motor 124. Therefore, in addition to being equipped to perform the V2V charging process 10 shown in FIG. 1, the respective electric powertrain systems 50D and 50R are also configured, during separately conducted discharging modes of the donor-side RESS 18 and recipient-side RESS 18, to electrically propel the corresponding donor EV 12D and recipient EV 12R. In other words, the donor EV 12D and recipient EV 12R in the illustrated embodiment of FIG. 1 are both mobile systems capable of performing propulsion functions apart from the described V2V charging process 10 described herein.

V2V CHARGING UNIT (14): Referring to FIG. 2, a situation could arise during operation of the recipient EV 12R in which its RESS 118 becomes charge-depleted to the extent that the recipient-side RESS 118 requires charging. When this occurs, the recipient EV 12R might not be in close proximity to an available EVSE charging station, or to a home or office charging station. In such a scenario, the owner/operator may request performance of the V2V charging process 10 of FIG. 1 as a mobile charging session, for instance via a software application (“app”). During this event, the portable V2V charging unit 14 may be transported to the site of the recipient EV 12R, e.g., via the donor EV 12D or another vehicle/third party provider or roadside assistance vehicle, and thereafter connected via charging cables 31 and attached connector 31C and the charging ports 16, 116, to the donor EV 12D and the recipient EV 12R. The charging ports 16 and 116 may be variously configured to receive SAE J1772, national charging standard (NACS), combined charging system (CCS), CHAdeMO, or other suitable charge connectors depending on the embodiment.

The donor EV 12D includes an onboard EV controller (CD) 32 having one or more processors (P) 36 and a non-transitory computer-readable storage medium/memory (M) 38. The recipient EV 12R is similarly equipped with a vehicle controller 132 (CR), processor(s) (P) 136, and memory (M) 138. Thus, the donor EV 12D and the recipient EV 12R are equipped to communicate via the exchange of data during the V2V charging process 10, manage and coordinate powerflow, monitor for proper connection of the charging cables 30 and other conditions/error states, regulate temperature of the V2V charging unit 14, and perform other relevant functions during the V2V charging process 10.

To perform the V2V charging process 10 using the DC-DC converter system 30 described herein, the vehicle controllers 32 and 132 work in concert with the V2V charging unit 14 to perform the process steps between input and output stages of the DC-DC converter system 30 as set forth below. Such functions are embodied computer-readable instructions and executed from the memory 38 and 138, for instance magnetic or optical media, CD-ROM, and/or solid-state/semiconductor memory (e.g., various types of RAM or ROM). The term “vehicle controller” and related terms such as control module, control unit, processor, and similar terms may refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). Non-transitory components of the memory 38 and 138 used herein are capable of storing machine-readable instructions in the form of one or more software or firmware programs or routines, combinational logic circuit(s), input/output circuit(s) and devices, signal conditioning and buffer circuitry and other components that can be accessed by one or more processors 36 and 136 to provide a described functionality.

In the representative and thus non-limiting configuration of FIG. 2, the V2V charging unit 14 is configured to output a rated charging power of at least about 50-100 kilowatts (kW) of continuous power, and about 150-300 amps (A) of continuous output current. In a possible construction, the V2V charging unit 14 may receive about 350-1000V or more from the donor EV 12D, and in response, may output about 150-1000V or more to the recipient EV 12R, with other voltage ranges being possible depending on the embodiment. The V2V charging unit 14 is also configured with buck/boost capabilities to enable the V2V charging unit 14 to decrease (buck) or increase (boost) the DC voltage (DC-1 of FIG. 1) provided from the donor EV 12D, with the V2V charging unit 14 doing so based on state of charge (SOC) or voltage capability of the recipient-side RESS 118 of the recipient EV 12R, an amount of requested power, power capability/SOC/voltage capability of the donor EV 12D, and other factors.

Mobile plug-in functions as contemplated herein involve the coordinated two-way communication of data between the donor EV 12D and the recipient EV 12R. Data exchange takes the form of a low-voltage control pilot or communications (Comms) signal, typically in the range of 0-12V, and a proximity voltage signal of 0-5V. An electrical ground (GND) is also provided. An established J1772 connection, for instance, allows respective processors of the donor EV 12D and the recipient EV 12R to communicate with each other using Power Line Communication (PLC) for the comms signal, which in turn progresses in accordance with an established communications protocol via a coordinated exchange of data messages. The comms signal is ordinarily used to verify a connection between an offboard EVSE charging station and a charging EV, whose respective places are taken herein by the donor EV 12D and the V2V charging unit 14 (together acting as such an EVSE charging station) and the recipient EV 12R, to communicate charging states. This may occur, e.g., using a fixed PWM duty cycle during the contemplated DC charging. The same signal may be used to adjust the charging rate as needed. Other standards such as the above-noted NACS, CCS, CHAdeMO, etc., may be used in a similar vein, and therefore the particular charging standard may vary with the desired end use.

A multi-pin charging connector 31C disposed on each of the charging cables 31 is connected to a corresponding one of the charging ports 16, 116 located on the donor EV 12D and recipient EV 12R, respectively. In accordance with the relevant charging protocol, DC charging power is fed through conductive pins of the charging port 16 of the donor EV 12D, across the V2V charging unit 14, and into the RESS 118 of the recipient EV 12R. The charging process is coordinated via an exchange of data/messages between the processor 36 of the donor EV 12D of FIG. 2, a processor or system controller 40 of the V2V charging unit 14, and the corresponding processor 136 the recipient EV 12R, e.g., a Battery Management System or another battery controller when the RESS 18 and/or 118 is embodied as a lithium-ion battery pack or another high-energy DC battery. The above-noted comms and proximity signals are exchanged between the processors 36 and 136 the system controller 40, with the general process of DC charging under DIN 70121 or other relevant protocols being well understood in the art. Also as understood in the art, such protocols proceed in accordance with a defined multi-step electronic “handshaking” process before permitting transfer of energy.

The V2V charging unit 14 illustrated in FIG. 2, which is specifically configured to function as a mobile charging accessory for performing a V2V charging event/session, may include a portable housing 41, for instance a weatherproof, rugged, and sufficiently lightweight enclosure constructed of molded plastic, aluminum, steel, etc. Portability of the housing 41 may be facilitated by connecting or affixing wheels and/or handles (not shown) to the housing 41. The housing 41 is also connected to respective inlet and outlet charging ports 42 and 142 of the V2V charging unit 14, which in turn are respectively connectable to the donor EV 12D and the recipient EV 12R during the V2V charging process 10 of FIG. 1.

The above-noted DC-DC converter system 30 as described below with reference to the remaining Figures is arranged within the housing 41, i.e., within a volume or space defined therein, and is connected to the housing 41 for secure transport and operation. In the illustrated embodiment of FIG. 2, the DC-DC converter system 30 may be configured as a boost-buck converter or a buck-boost converter in the different representative embodiments of FIGS. 3A and 3B, respectively. A high-voltage-to-low-voltage (HV-LV) converter 43 may also be included in the circuitry of the V2V charging unit 14. An optional LV energy storage device 45, e.g., an electrochemical battery pack, an ultracapacitor, or a supercapacitor in different implementations, may be connected to a low-voltage side of the HV-LV converter 43 as shown, or LV power could be provided separately, e.g., via a plug-in connection to onboard/on-vehicle 12-15V power.

The optional LV energy storage device 45 when used is also electrically connected to the DC-DC converter system 30 to provide low-voltage (e.g., nominal 12-15V) power suitable for opening/closing HV disconnect devices 47 and 147, and for powering voltage or current sensors and associated circuit and diagnostic components. The connection of the LV energy storage device 45 and the HV-LV converter 43 also enables the HV-LV converter 43 to selectively charge the LV energy storage device 45 during the V2V charging process 10. The optional LV energy storage device 45 may also be recharged via AC grid power in some configurations, e.g., by plugging the housing 41 into an available wall socket via a corresponding charging outlet (not shown) arranged thereon.

The V2V charging unit 14 illustrated in FIG. 2 also includes a communication processing unit 49 operable for establishing and maintaining two-way communication between the donor EV 12D and the recipient EV 12R during the V2V charging process 10 of FIG. 1. Separate communication circuits/stacks or “comm stacks” 149 and 249 (Comm S) may be included in the communication processing unit 49, with an application layer 51 arranged therebetween to coordinate wired/wireless data exchange. Comm stacks 149 and 249 in the non-limiting embodiment of FIG. 2 may include different connections and components, e.g., a ground (GND) connection 52A, an SAE J1772 PWM block 52B, and a PLC processor 52C for the comms stack 149, or equivalent structure in other embodiments, and corresponding ground connection 152A, PWM block 152B, and process 152C for the comms stack 249.

To that end, the CPU 49 may be equipped, during the V2V charging process 10, to coordinate with the above-noted processors 36 and 136 of the respective donor EV 12D and recipient EV 12R. Communication is facilitated via one or more communication modules connected to/usable with the application layer 51, e.g., a BLE/WiFi/LTE software module 53, ISO-20 communications software module 54, DIN communications software module 55, and ISO-3 communications software module 56 as shown in the non-limiting example construction of FIG. 2. Such software is typically used during EV charging to facilitate the wireless exchange of data, and thus is well understood in the art.

Still referring to FIG. 2, by using the comms stacks 149 and 249, the application layer 51, and the associated software modules 53, 54, and 55, the CPU 49 is able to command the HV-LV converter 43 to pre-charge an HV bus 60 of the V2V charging unit 14 to a level equal to that of an HV bus located on the donor EV 12D, and in selectively recharging the LV energy storage device 45 via the HV-LV converter 43 as needed. Additionally, the CPU 49 (in close coordination with the processors 36 and 136 of FIG. 2) selectively commands offloading of a DC charge from the donor-side RESS 18 of the donor EV 12D of FIGS. 1 and 2 to the recipient-side RESS 118 of the recipient EV 12R through operation of the DC-DC converter system 30.

The DC-DC converter system 30 described below is connectable on positive and negative HV rails (+,−) between the inlet charging port 42 and the outlet charging port 142 via the first and second sets of HV disconnect devices 47 and 147, respectively. Fault isolation devices (F) such as fuses, pyrotechnic switches, or e-fuses may be arranged as shown to provide additional high-voltage protection.

Other components of the V2V charging unit 14 of FIG. 2 may include a human-machine interface (HMI) 62 connected to the housing 41 and configured to facilitate interaction-machine interactions during the course of the V2V charging process 10 described herein. The HMI 62 may receive user inputs to the system controller 40 during the V2V charging process 10, and may also display information pertaining to the V2V charging process 10 for viewing by users of the V2V charging unit 14. For example, the HMI 62 could include one or more display screens, alphanumeric touchscreens, push button keyboards, and/or other peripheral devices that present prompts and sequential instructions for the owner/operator to follow. The HMI 62 could likewise present information to the user(s), such as the current communication and charge offloading statuses of the V2V charging process 10, SOC, voltage, or other status of the batteries 18 and 118 of the respective donor EV 12D and recipient EV 12R, charging time and offloaded power total, etc. A controller area network (CAN) bus may be included in the architecture of the V2V charging unit 14 to communicate between the various modules or devices using low-voltage differential signals.

Additionally, a thermal management system (TMS) 25 may be incorporated into the V2V charging unit 14 or connected thereto to regulate the temperature of high-voltage and other components contained therein, in particular the DC-DC converter system 30 and the optional HV-LV converter 43. By way of example and not of limitation, the thermal management system 25 may include a heat sink with conductive and/or forced convective devices, e.g., cooling plates, fans, etc., fluidic means such as coolant loops/pumps, cooling blankets, and the like. In some implementations, the thermal management system 25 could include optional phase change materials to optimize mass, transient heat rejection capability, etc.

BOOST-BUCK OPTION: Referring now to FIG. 3A, the above-noted DC-DC converter system 30 of FIGS. 1 and 2 may be optionally configured as a boost-buck converter system 30A. As appreciated in the art, such a configuration may be used to reduce (“buck”) or increase (“boost”) an input voltage (Vi), in this case from the donor EV 12D of FIGS. 1 and 2. As configured, the boost-buck converter system 30A includes a boost converter circuit stage (“boost stage”) 150 and buck converter circuit stage (“buck stage”) 250, and selectively-actuatable first and second bypass switches S1 and S2, e.g., electromechanical relays or contactors. The boost stage 150 is connected to the donor-side battery and the buck stage 250 is connected to the recipient-side battery. Use of the embodiment of FIG. 3A may be used to eliminate switching and conduction losses in part or the whole of one stage of the power conversion process as noted above. The FIG. 3A embodiment in particular may be implemented to minimize a ripple current between the donor EV 12D and the recipient EV 12R, due in part to the inclusion of respective first and second inductors 34 and 134.

In a representative scenario in which the input voltage (Vi) from the donor EV 12D is about 400V and an output voltage (Vo) to the recipient EV 12R is about 800V, for instance, only the boost stage 150 is used. In other words, the buck stage 250 located downstream of the boost stage 150 is not needed. This allows the system controller 40 (FIG. 2) to selectively bypass the buck stage 250 via operation of the second bypass switch S2. A similar approach may be used to bypass the boost stage 150 via control of the first bypass switch S1 in FIG. 3A when the input voltage (Vi) from the donor EV 12D is about 800V and an output voltage (Vo) to the recipient EV 12R is about 400V. In that exemplary case, only the buck stage 250 is used. The boost stage 150 located upstream of the buck stage 250 is not needed. The above-noted losses are thereby reduced by not having to use both stages of the DC-DC converter system 30A.

In the illustrated topology of FIG. 3A, the input voltage (Vi) is applied to an input stage of the DC-DC converter system 30A as shown. An input filter capacitor 37 is charged to the level of the input voltage (Vi) provided at the input stage in this embodiment. An inductor 34 is connected between input node N1 and switching node N2 of the boost stage 150. In this particular configuration, a lower switch SB connects the switching node N2 to the negative voltage rail 60⁻. An upper switch SA, which may be alternatively embodied as a simple freewheeling diode for simplicity, similarly connects the switching node N2 to the positive voltage rail 60⁺ at the point labeled V⁺. Thus, “upper switch” refers herein to connection to the positive voltage rail 60⁺, and “lower switch” refers to connection to the negative voltage rail 60″.

The respective lower and upper switches SB and SA are controlled in the ordinary course of controlling the boost stage 150 using complementary pulse width modulation (PWM) control signals (PWM2 and \PWM2) from the controller 40. The duty cycle of such complementary PWM control signals is used to control the charging current, charging voltage, or charging power of the recipient EV 12R, as appreciated in the art. The first bypass switch S1 in this particular embodiment may be controlled to selectively bypass the first stage of power conversion, i.e., the boost stage 150. When the boost stage 150 is selectively bypassed by closing the first bypass switch S1, the switches SA and SB are disabled or kept in an OFF state (open or non-conducting) by the system controller 40, with exemplary switching logic described below with reference to table 33 of FIG. 4.

A DC link capacitor (C_{L}) 35 is also disposed between circuitry of the boost and buck stages 150 and 250 in the representative construction of FIG. 3A. Similar to the boost stage 150, the buck stage 250 includes respective upper and lower switches SC and SD. An output inductor 134 is connected between respective switching and output nodes N3 and N4 of the buck stage 250, with an output filter capacitor 137 connected to the negative voltage rail 60⁻ in FIGS. 3A and 3B. In this configuration, the upper switch SC (i.e., connected to the positive voltage rail V⁺), connects the switching node N3 to the positive voltage rail V⁺. The lower switch SD, which may be optionally embodied as a simple freewheeling diode, similarly connects the switching node N3 to the negative voltage rail 60⁻.

In this implementation, the respective upper and lower switches SC and SD are controlled in the ordinary course of controlling the circuit of the buck stage 250 using complementary PWM control signals (PWM1 and \PWM1) from the system controller 40. As noted above, the commanded duty cycle of the complementary PWM control signals in this instance controls the charging current, charging voltage, or charging power of the recipient EV 12R. Analogous to the first bypass switch S1, the second bypass switch S2 is controlled to selectively bypass the buck stage 250. When the buck stage 250 is selectively bypassed, the switches SC and SD are disabled or kept in OFF state by the controller. Control of the first and second bypass switches S1 and S2 as well as the switches SA, SB, SC, and SD is described below with reference to table 33 of FIG. 4.

BUCK-BOOST OPTION: Referring to FIG. 3B, the above-noted DC-DC converter system 30 of FIGS. 1 and 2 may alternatively configured as a buck-boost converter 30B in which the first inductor 34 is shared between the boost stage 150 and the buck stage 250. The boost stage 150 in such a configuration is connected to the recipient-side battery and the buck stage 250 is connected to the donor-side battery. As with the exemplary FIG. 3A configuration, various switches or power conversion stages are able to be selectively bypassed in the alternative topology of FIG. 3B, where the respective first and second bypass switches S1 and S2 are located differently from FIG. 3A while serving same purpose, i.e., first bypass switch S1 is used to bypass the boost stage 150 and the second bypass switch S2 is used to bypass the buck stage 250.

Referring briefly to the table 33 of FIG. 4, control of the boost-buck converter 30A of FIG. 3A may be performed by the system controller 40 of FIG. 2 or another suitable processing node based on the input and output voltages Vi and Vo. A calibratable/predetermined threshold differential voltage (Vth) is also used by the system controller 40 to determine a corresponding ON/OFF state of the respective first and second bypass switches S1 and S2, e.g., about 50V in a representative use case, or about 1/10^{th} or 10-percent (10%) of the nominal voltage range used during the V2V charging process 10 of FIG. 1, or another predetermined fraction or percentage. In one or more embodiments, the first bypass switch S1 and the second bypass switch S2 may be optionally configured as solid-state switches, e.g., solid-state relays, having an ON state voltage of less than about 10-percent (10%) to 20% of an ON-state voltage of remaining switches SA, SB, SC, and SD in the buck stage 250 and the boost stage 150. The table 33 may be programmed into memory accessible by the system controller 40 so that the ON/OFF states may be quickly selected and implemented in real-time based on the present values of Vi and Vo to the respective input and output stages of power conversion.

Using table 33, the system controller 40 may command the first bypass switch S1 to close (X) and the second bypass switch S2 to open (O) when the input voltage (Vi) exceeds the sum of the required output voltage (Vo) and the threshold differential voltage (Vth), i.e., Vi>Vo+Vth. This action established a “buck mode only” mode of operation. In this case, the switches SA and SB are turned off (i.e., opened) and the switches SC and SD are controlled via complementary PWM signals PWM1 and \PWM1, i.e., the PWM signals PWM1 and \PWM1 are 180° out of phase with one another.

The opposite control action is commanded by the system controller 40 when the sum of the input voltage (Vi) and the threshold differential voltage (Vth) is less than the required output voltage (Vo), i.e., when Vi+Vth<Vo. Then, the system controller 40 opens the first bypass switch S1 and closes the second bypass switch S2 for a “boost mode only” mode of operation. During this mode, the switches SA and SB are controlled via complementary PWM signals PWM2 and \PWM2. Switches SC and SD are turned off, i.e., commanded to open (O).

As a third “buck-boost” control option, the system controller 40 may open both the first and second bypass switches S1 and S2 when the absolute value of a difference between the input and output voltages is less than or equal to the threshold differential voltage (Vth), i.e., |Vᵢ−Vₒ|≤Vₜₕ. The system controller 40 may thereafter maintain the first and second bypass switches S2 in an OPEN state (i.e., turned off) when the voltage level of the donor-side battery overlaps or stays within a predetermined range of a voltage level of the recipient-side battery during the charging process. This action allows buck-boost (or boost-buck) operation as needed to control the charging current, charging voltage, or charging power of the recipient EV 12R. In this case, complementary PWM signals (PWM1, \PMW1) and (PWM2, \PWM2) are applied with appropriate duty cycles to the switches SC, SD used for the buck stage, and the switches SB and SA used for the boost stage. Such a control scheme also applies to the topology of FIG. 3B.

Table 33 lends itself to performance of a switching control method in the course of performing the V2V charging process 10 of FIG. 1 using the DC-DC converter system 30. To implement such a method, computer-readable instructions are executable by the system controller 40 of FIG. 2 or by another processing node in response to voltage comparison results. Looking at the representative table 33 of FIG. 4, for example, such a method may include identifying, via the system controller 40, respective voltage ranges of the donor-side ESS 18 and the recipient-side ESS 118 of the donor EV 12D and the recipient EV 12R, respectively. The system controller 40 would then compare the respective input and output voltages Vi and Vo to determine an appropriate state for the first and second bypass switches S1 and S2. Comparison may entail accessing a pre-populated lookup table, e.g., table 33 of FIG. 4, and selecting a corresponding state in accordance with the table 33. As noted above, table 33 corresponds to the topologies of FIGS. 3A and 3B.

Such a method thus continues by action of the system controller 40 or other dedicated processing node in selectively bypassing a charging path in the boost stage 150 or the buck stage 250 of the DC-DC converter system 30, for instance of the V2V charging unit 14 of FIG. 1 when connected between the donor EV 12D and the recipient EV 12R. This action may occur by closing the first bypass switch S1 in the boost stage 150 or the second bypass switch S2 in the buck stage 250 to minimize switching and conduction losses in the DC-DC converter system 30 as set forth above. Methods as disclosed herein may be embodied as software stored on a tangible non-transitory medium such as flash memory, solid-state drive (SSD) memory, hard-disk drive (HDD) memory, CD-ROM, digital versatile disk (DVD), or another suitable computer-readable storage devices. Further, although specific algorithms may be described with reference to flowcharts and/or workflow diagrams herein, alternative methods for implementing the example machine-readable instructions may be used.

The solutions presented herein therefore help improve efficiency during the V2V charging process 10 of FIG. I due to multiple stages of power conversion in the energy flow path between the donor EV 12D and the recipient EV 12R. Constructing the first and second bypass switches S1 and S2 as low conduction loss switches, e.g., electromechanical contactors or relays, or possibly SSRs, may be implemented in bidirectional or unidirectional boost-buck or buck-boost converter topologies to bypass an appropriate stage or switch SA, SB, SC, or SD to minimize losses in the DC-DC converter system 30. These and other attendant benefits will be readily appreciated by those skilled in the art now having the benefit of the foregoing disclosure.

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, “any” and “all” shall both mean “any and all”, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A direct current-to-direct current (DC-DC) converter system for use in a charging session performed between a charge-providing electrical system (“donor”) and a charge-receiving electrical system (“recipient”), the DC-DC converter system comprising:
an input filter capacitor that connects an input stage of the DC-DC converter system to a rechargeable energy storage system of the donor (“donor-side RESS”);
an output filter capacitor that connects an output side of the DC-DC converter system to a rechargeable energy storage system of the recipient (“recipient-side RESS”);
a link capacitor disposed in parallel with and between the input stage and the output stage;
a boost converter circuit stage (“boost stage”) having a first switching control circuit, wherein the first switching control circuit includes a first plurality of switches having a first bypass switch;
a buck converter circuit stage (“buck stage”) having a second control circuit, wherein the second switching control circuit includes a second plurality of switches having a second bypass switch; and
a system controller in communication with the first plurality of switches and the second plurality of switches, wherein the system controller is configured to:
identify respective voltage ranges of the donor-side RESS and the recipient-side RESS; and
in response to the respective voltage ranges, selectively bypass a charging path in the boost stage or the buck stage by closing the first bypass switch or the second bypass switch to thereby minimize losses in the DC-DC converter system.

2. The DC-DC converter system of claim 1, wherein the boost stage is connected to the donor-side RESS and the buck stage is connected to the recipient-side RESS, such that the DC-DC converter system is configured as a boost-buck converter.

3. The DC-DC converter system of claim 2, wherein the system controller is configured to selectively bypass the boost stage or the buck stage by respectively opening or closing the first bypass switch or the second bypass switch.

4. The DC-DC converter system of claim 2, wherein the system controller is programmed to:
close the first bypass switch and open the second bypass switch when the input voltage exceeds the output voltage by more than a predetermined fraction; and
close the second bypass switch and open the first bypass switch when the output voltage exceeds the input voltage by more than the predetermined fraction.

5. The DC-DC converter system of claim 1, wherein the boost stage is connected to the recipient-side RESS and the buck stage is connected to the donor-side RESS, such that the DC-DC converter system is configured as a buck-boost converter.

6. The DC-DC converter system of claim 5, wherein the system controller is configured to selectively bypass an upper switch of the buck-boost converter via the first bypass switch or the second bypass switch.

7. The DC-DC converter system of claim 5, wherein the system controller is programmed to:
close the first bypass switch and open the second bypass switch when the input voltage exceeds the output voltage by more than a predetermined fraction; and
close the second switch and open the first bypass switch when the output voltage exceeds the input voltage by more than the predetermined fraction.

8. The DC-DC converter system of claim 1, wherein the system controller is configured to maintain the first bypass switch and the second bypass switch in an OPEN state when a voltage level of the donor-side RESS overlaps or stays within a predetermined range of a voltage level of the recipient-side RESS during the charging process.

9. The DC-DC converter system of claim 1, wherein the system controller is configured to pre-charge the input filter capacitor, the output filter capacitor, and the link capacitor prior to closing the first bypass switch or the second bypass switch to minimize an inrush current.

10. The DC-DC converter system of claim 1, wherein the DC-DC converter system is bi-directional.

11. The DC-DC converter system of claim 1, wherein the first bypass switch is connected between an input node and a switching node of the boost stage, and the second bypass switch is connected between a switching node and an output node of the buck stage.

12. The DC-DC converter system of claim 1, wherein the first bypass switch and the second bypass switch are solid-state switches having an ON state voltage that is less a predetermined fraction of an ON-state voltage of remaining switches in the first switching circuit and the second switching circuit at a rated current level of the buck stage and the boost stage.

13. The DC-DC converter system of claim 1, wherein the first bypass switch and the second bypass switch include an electromechanical relay or contactor.

14. The DC-DC converter system of claim 1, wherein the DC-DC converter system is part of a vehicle-to-vehicle (V2V) charging unit, the system controller is part of the V2V charging unit, the donor and recipient are electric vehicles, and the donor-side RESS and the recipient-side RESS are traction battery packs.

15. A vehicle system comprising:
a charge-providing donor electric vehicle (EV) having a donor-side rechargeable energy storage system (RESS);
a charge-receiving recipient EV having a recipient-side RESS; and
a vehicle-to-vehicle (V2V) charging unit having a system controller and a DC-DC converter system for use in performing a V2V charging process between the donor EV and the recipient EV, the DC-DC converter comprising:
an input filter capacitor connected at an input stage of the DC-DC converter to the donor-side RESS;
an output filter capacitor connected at an output stage of the DC-DC converter to the recipient-side RESS;
a link capacitor disposed in parallel with and between the input stage and the output stage;
a boost converter circuit stage (“boost converter”) having a first switching control circuit, the first switching control circuit including a first plurality of switches having a first bypass switch; and
a buck converter circuit stage (“buck converter”) having a second control circuit, the second switching control circuit including a second plurality of switches having a second bypass switch, wherein the system controller is configured to:
identify respective voltage ranges of the donor-side RESS and the recipient-side RESS; and
in response to the respective voltage ranges, selectively bypass a charging path in the boost stage or the buck stage by closing the first bypass switch or the second bypass switch to thereby minimize losses in the DC-DC converter system.

16. The vehicle system of claim 15, wherein the boost stage is connected to the donor-side RESS and the buck stage is connected to the recipient-side RESS, such that the DC-DC converter system is configured as a boost-buck converter.

17. The vehicle system of claim 15, wherein the boost stage is connected to the recipient-side RESS and the buck stage is connected to the donor-side RESS, such that the DC-DC converter system is configured as a buck-boost converter.

18. The vehicle system of claim 15, wherein the system controller is configured to maintain the first bypass switch and the second bypass switch in an OPEN state when a voltage level of the donor-side RESS overlaps or stays within a predetermined range of a voltage level of the recipient-side RESS during the V2V charging process.

19. A vehicle-to-vehicle (V2V) charging method, comprising:
identifying, via a system controller, respective voltage ranges of a donor-side rechargeable energy storage system (RESS) and a recipient-side RESS of a donor electric vehicle (EV) and a recipient EV, respectively; and
in response to the respective voltage ranges, selectively bypassing a charging path in a boost converter circuit stage (“boost stage”) or a buck converter circuit stage (“buck stage”) of a direct current-to-direct current (DC-DC) converter system of a V2V charging unit connected between the donor EV and the recipient EV when charging the recipient-side RESS via the donor-side RESS, including closing a first bypass switch in the boost stage or a second bypass switch in the buck stage to minimize losses in the DC-DC converter system.

20. The V2V charging method of claim 19, wherein the first bypass switch and the second bypass switch are solid-state switches having an ON state voltage that is less than a predetermined fraction of an ON-state voltage of remaining switches in the buck stage and the boost stage.
